(19) United States
(12) Patent Application Publication
(10) Pub. No.: US 2004/0143440 A1
(43) Pub. Date: Jul. 22, 2004

(54) VEHICLE SPEECH RECOGNITION SYSTEM

(76) Inventors: Venkatesh Prasad, Ann Arbor, MI (US); Bryan Goodman, Dearborn, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/707,671

(22) Filed: Dec. 31, 2003

Related U.S. Application Data
(60) Provisional application No. 60/437,784, filed on Jan. 3, 2003.

(51) Int. Cl. G10L 21/00

(52) U.S. Cl. 704/270

(57) ABSTRACT

The present invention provides a dialog-based vehicle control system that responds to both voice commands and to a vehicle occupant interacting with a human control interface. The vehicle control system of the invention includes one or more vehicle components that adjust secondary vehicle functions, a dialog-based speech recognition component that responds to voice commands from a vehicle occupant, and a human machine interface that also communicates with the one or more vehicle components. In another embodiment of the invention, a method for controlling secondary vehicle functions is provided.

### CROSS REFERENCE TO RELATED APPLICATIONS

This application claims the benefit of U.S. provisional application Serial No. 60/437,784 filed Jan. 3, 2003, which is hereby incorporated by reference.

### BACKGROUND OF INVENTION

1. Field of the Invention

The present invention is related to a vehicle system for controlling secondary vehicle functions by responding to both voice commands and input provided to a human machine interface.

2. Background Art

As computer technology has advanced, vehicle control systems incorporating such technology have also become more sophisticated. Recently, speech activated control strategies have been implemented in automobiles to provide rudimentary control of various vehicle systems. Typically, a speech to text recognition software module being executed on a microcomputer is at the core of these strategies. Accordingly, these systems to a significant degree are limited by the accuracy of the speech recognition module.

A currently utilized vehicle recognition system provides a one to one mapping in which a set of predetermined voice commands are mapped to a particular action to be implemented by the control system. These systems tend to be somewhat inflexible do to the nature of the mapping. Moreover, these systems require that the user remember a relatively large number of voice commands to be efficiently utilized.

U.S. Pat. No. 6,240,347 (the '347 patent) discloses an alternative vehicle control system using speech recognition and a central display/control unit having dedicated and reconfigurable push buttons to control individual vehicle accessories. The system of the '347 patent is capable of operating in a complementary fashion or in a standalone mode. The control system of the '347 patent may be used to control various vehicle electronics accessories “such as navigation systems, audio systems, climate control systems, audio and video disc players, power windows and mirrors, door locks, clocks, interior and exterior lights, information gauges and displays, and powered position setting of seats, steering wheels, and floor pedals.” Moreover, the system of the '347 patent provides rudimentary feedback regarding the functions being controlled and the states of the controls for the electronic accessories. Specifically, the system is able to provide this feedback as audible feedback. Although the system of the '347 patent works well, this system does not provide a truly dialog based system. A dialog based vehicle control system is a system in which the vehicle occupant speaks voice commands to which the control system not only provides audible information regarding the current state of the system but also prompts the occupant on how to proceed. A dialog based system offers distinct advantages for the user since these systems would require that the user only remember a relatively few commands without having to refer to a display as used in the '347 patent.

Accordingly, there exists a need for an improved speech recognition based vehicle control system that provides a dialog based interaction with the vehicle occupant which operates in combination with a human machine interface.

### SUMMARY OF INVENTION

The present invention overcomes the problems of the prior art by providing in one embodiment, a vehicle control system that responds to both voice commands and to a vehicle occupant interacting with a human control interface. The vehicle control system of the invention comprises one or more vehicle components that adjust secondary vehicle functions, a dialog-based speech recognition component that responds to voice commands from a vehicle occupant, and a human machine interface that also communicates with the one or more vehicle components.

In another embodiment of the invention, a method for controlling secondary vehicle functions is provided. The method of this embodiment is advantageously deployed by the system of the invention.

### BRIEF DESCRIPTION OF DRAWINGS

FIG. 1 is a schematic of the vehicle control system of the invention;

FIG. 2 is a flowchart illustrating selection of the various control modes used by the system of the invention;

FIG. 3 is a flowchart illustrating the operation of the climate control mode that may be used by the system of the present invention;

FIG. 4 is a flowchart illustrating the operation of a navigation control mode;

FIG. 5 is a flowchart illustrating the operation of a communications control mode that may be used by the system of the present invention;

FIG. 6 is a flowchart illustrating the operation of an entertainment control mode that may be used by the system of the present invention;

FIG. 7 is a flowchart illustrating the operation of audio controls that may be used by the system of the present invention;

FIG. 8 is a flowchart illustrating the operation of a vehicle systems control mode that may be used by the system of the present invention.

### DETAILED DESCRIPTION

Reference will now be made in detail to presently preferred compositions or embodiments and methods of the invention, which constitute the best modes of practicing the invention presently known to the inventors.

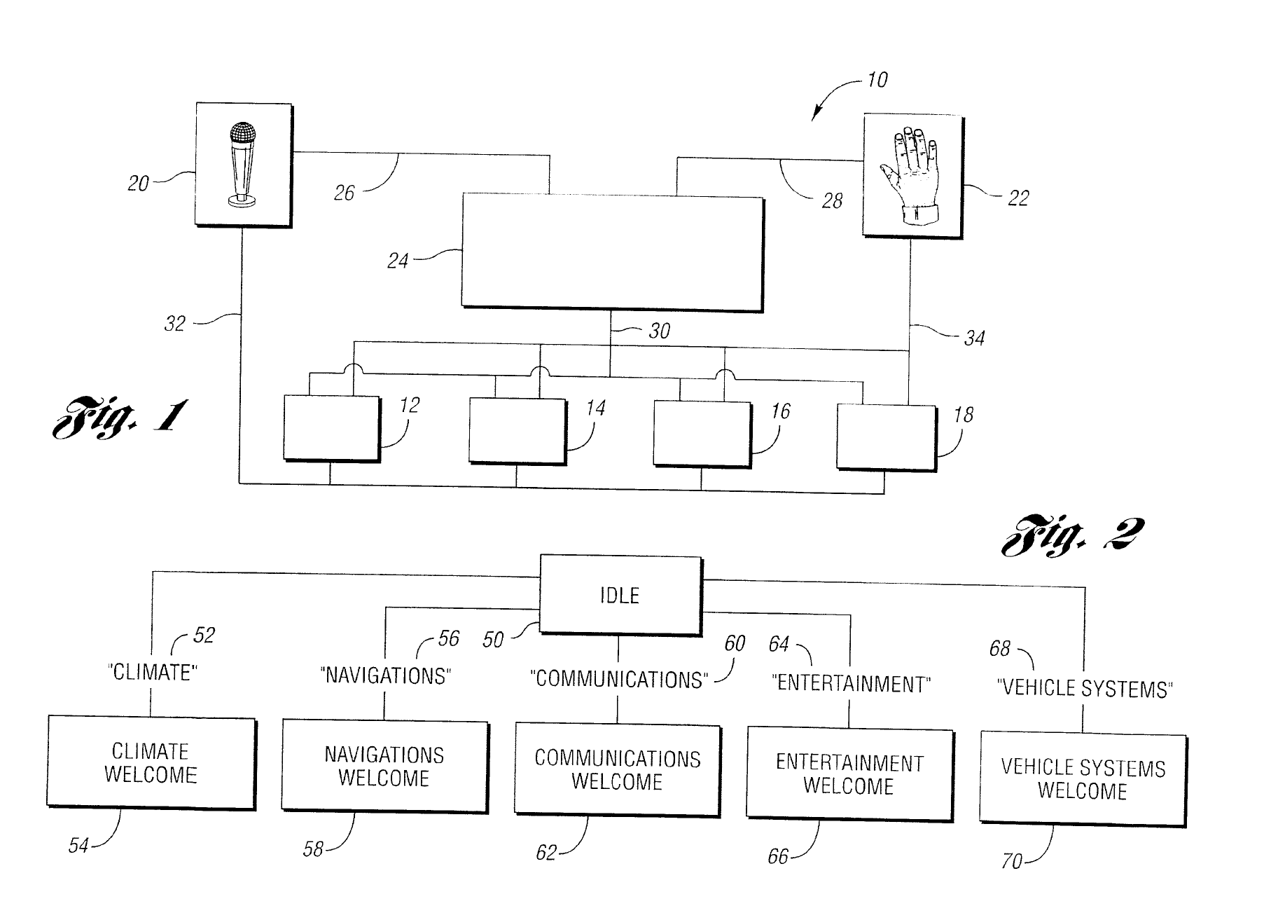

In an embodiment of the present invention, a dialog-based vehicle control system is provided. With reference to FIG. 1, vehicle control system 10 comprises vehicle components 12, 14, 16, 18 that adjust secondary vehicle functions. As used herein, “secondary vehicle functions” are those vehicle activities not directly involved with control of a vehicle's movement (e.g., acceleration, braking, turning, and the like.) Examples of vehicle components that adjust secondary vehicle functions include components of the entertainment system (i.e., radio, CD player), the communications system (i.e., cell phone), vehicle climate system (i.e., air conditioning), navigation system (i.e., GPS Satellite Navigation System), and the like. Vehicle control system 10 further comprises speech recognition component 20 that responds to voice commands from a vehicle occupant. Finally, vehicle control system further comprises human machine interface (“HMI”) 22 that also communicates with the vehicle components 12, 14, 16, 18. In particular, human machine interface 22 may communicate with the vehicle components 12, 14, 16, 18 in combination with or separate from the speech recognition component 20.

A number of alternatives known to those skilled in the art of control systems exist for utilizing the vehicle occupant's input to speech recognition component 20 or to human machine interface 22. Both speech recognition component 20 and human machine interface 22 may communicate either directly or indirectly with vehicle components 12, 14, 16, 18. Indirect communication, may be realized by interfacing electronics system 24 via connections 26, 28. Interfacing electronics system 24 provides a primary control analog or digital signal along cables 30 to vehicle components 12, 14, 16, 18. “Primary control” as used herein means a signal that is directly applied to a vehicle component for the purposes of controlling that component. A particularly preferred interfacing electronics systems in disclosed in U.S. patent application Ser. No. 10/637418 filed Aug. 8, 2003. The entire disclosure of this application is hereby incorporated by reference. Alternatively, a multiplex network and multiplex interfaces may be used in place of interfacing electronics system 24. The use of such multiplex network and interfaces is disclosed in U.S. Pat. No. 6,240,347, the entire disclosure of which is hereby incorporated by reference. In this variation speech recognition component 20 comprises a translating component that translating a voice command into a secondary control digital or analog signal which is provided to interfacing electronics system 24. Similarly, human machine interface 22 comprises a translating component for translating the voice command into a secondary control digital or analog signal which is provided to the interfacing electronics system 24. Direct communication from speech recognition component 20 and human machine interface 22 may occur by providing a control signal via connection 32, 34. In this variation, either speech recognition component 20 or human machine interface 22 may include a translating component that translates a voice command into a digital or analog signal which is provided to vehicle components 12, 14, 16, 18.

The speech recognition component is an important component of the present invention. This component will typically comprise a first translating component for translating a voice command from a vehicle occupant into a form that may be used to control a vehicle subsystem or component via a control signal. Typically, the translating component will translate a voice command into a sequence of bits that represent the text of the voice command. Example of software speech recognition modules that convert speech to text include SpeechWorks VoCon 3200, SpeechWorks VoCon SF, and SpeechWorks ASR each commercially available from Scansoft, Inc. located in Peabody, Mass. This text data may then be interpreted to control vehicle components. After the vehicle occupant has spoken a command, then a prompting component evaluates the sufficiency of the voice command. If more information is need from the occupant, the prompting component will prompt the vehicle occupant for additional input information. The prompting may be generated by combining one or more pre-recorded audio files, or some combination of pre-recorded audio files and computer-generated text to speech audio. Examples of software modules that provide text to speech audio include SpeechWorks RealSpeak Solo, SpeechWorks RealSpeak PC/Multimedia, and SpeechWorks RealSpeak TTS-2500 each commercially available from Scansoft, Inc. Typically, this additional information is a vehicle parameter for which information in the voice command was not provided. The prompting component will prompt the vehicle occupant iteratively until enough information to invoke a change to the vehicle systems is provided. Finally, the speech recognition component also includes a second translating component for translating the information provided after prompting into a form which communicates a control signal to the one or more secondary vehicle components. The speech control component is typically a central processing unit (“CPU”)executing a sequence of computer commands (i.e., a computer program or software package) that translates the voice command into a signal that is communicatable to the one or more system components. When a CPU is used as the speech recognition component, the first translating component, the prompting component, and the second translating component may be a particular sequence of computer commands or a subroutine. Moreover, the first and second translating components may include the same sequence of computer commands or the same subroutines.

The vehicle control system of the invention also includes a human machine interface. As used herein, “human machine interface” refers to any device used by a user to act on a vehicle component or system. The definition as used herein excludes the speech recognition component set forth above. Example of human machine interfaces include, but are not limited to, touch panel displays, switches, capacitance sensors, resistive sensors, wheels, knobs, cameras, and the like.

In a particularly useful variation of this embodiment, the vehicle control system comprises a module for grouping parameters together for each secondary vehicle function to form a vehicle control mode. The vehicle control mode being selectable by a vehicle occupant such that the vehicle occupant may then specify parameters for a selected vehicle control mode. A control mode may be selected by the vehicle occupant by voice command or by the vehicle occupant interacting with the human machine interface. Control modes which have been found useful include, for example, a climate control mode, a communications mode, an entertainment mode, a navigation mode, and a general vehicle systems mode. The climate control is used by the vehicle occupant to specify parameters that adjust climate in a vehicle passenger compartment. The communications mode is used by the vehicle occupant to specify parameters for operating a telephone (e.g., a cell phone) located in the vehicle passenger compartment. The entertainment mode is used by the vehicle occupant to specify parameters that control a vehicle entertainment system. The navigation mode is used by the vehicle occupant to specify parameters related to vehicle position. Finally, the inclusion of a vehicle system mode has also been found useful. The vehicle systems mode as used herein refers to a mode in which the vehicle occupant is able to specify parameters related to the vehicle control system itself or any other predetermined vehicle parameter that is not directly related to vehicle movement. As will become apparent from the flowchart described below, it is advantageous to further divide these user selectable modes into submodes which further group parameters that may be specified by the vehicle occupant.

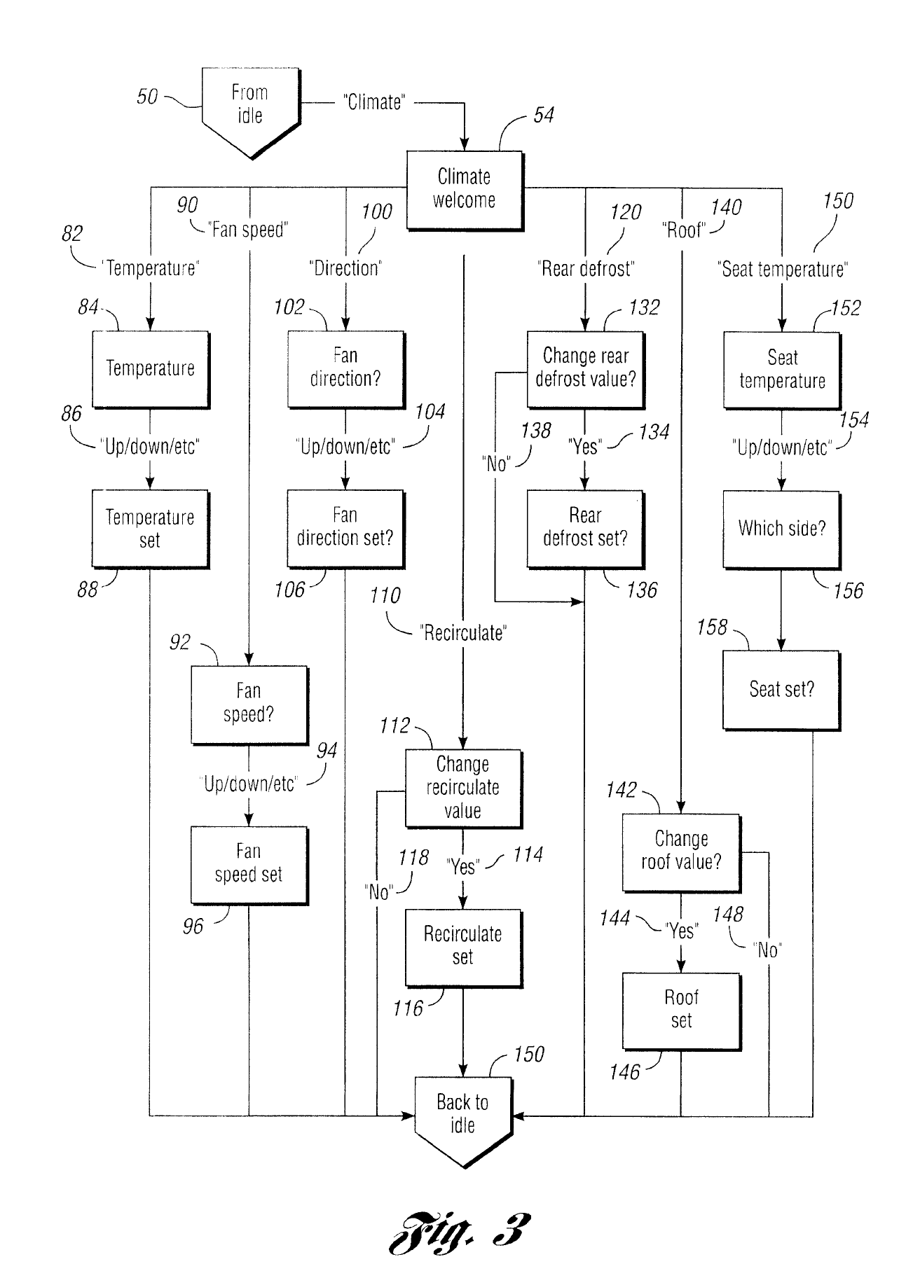

With reference to FIG. 2, a flowchart demonstrating selection of control modes is provided. Initially, the vehicle control system is in an idle state as indicated by block 50. The user selects a control mode to enter by either saying the name of the control mode to enter or by interacting with the HMI. For example, the user may say “climate” as indicated by label 52 to enter the climate control mode as represented by block 54. Similarly, the user may say: “navigation” as indicated by label 56 to enter the navigation control mode as represented by block 58; “communications” as indicated by label 60 to enter the communications control mode as represented by block 62; “entertainment” as indicated by label 64 to enter the entertainment control mode as represented by block 66; or “vehicle systems” as indicated by label 68 to enter the “vehicle systems control mode as represented by block 70.

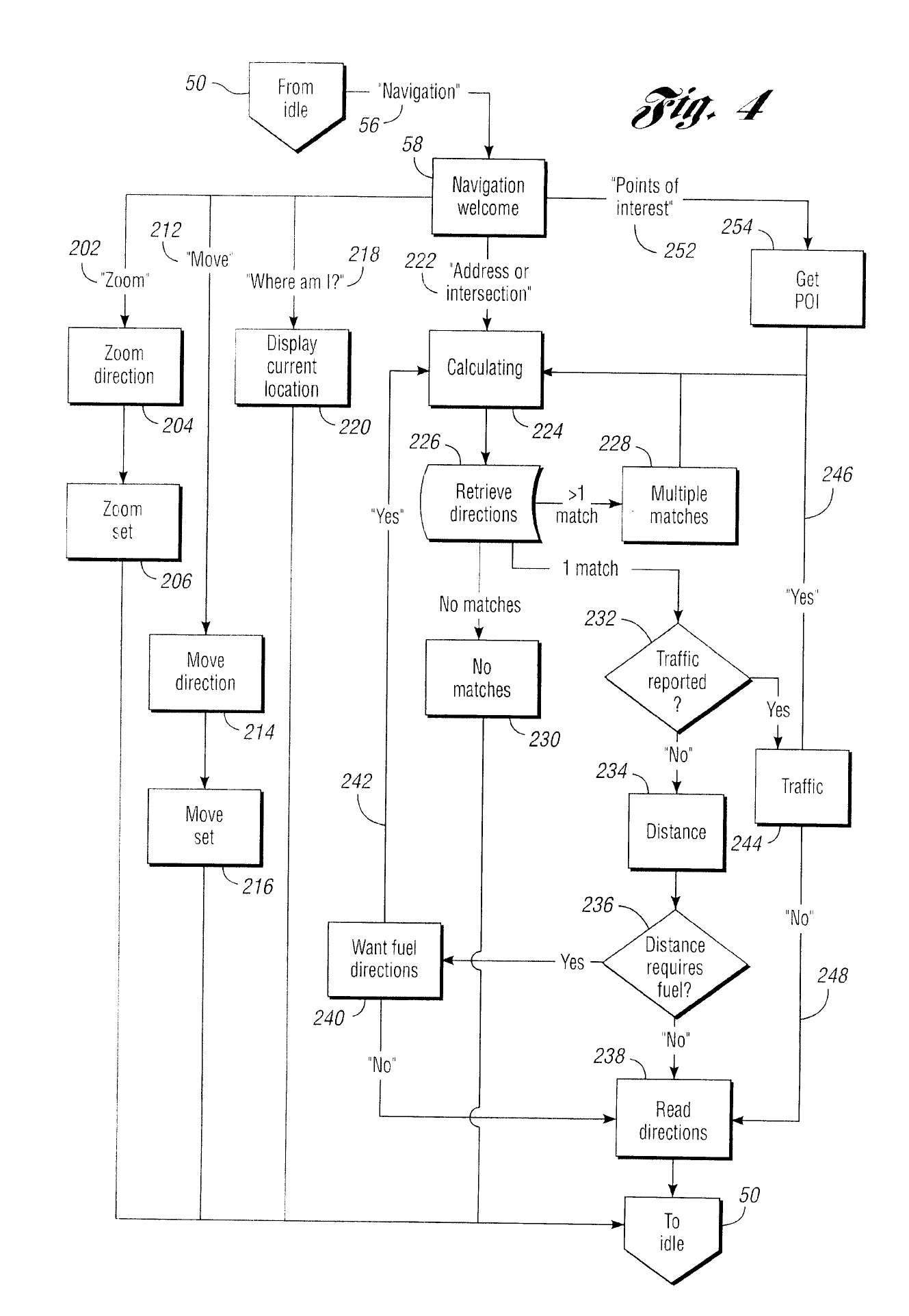

With reference to FIGS. 3 to 8, the interaction between the vehicle control system of the invention and the vehicle occupant (the “user”) for each control mode is provided. FIG. 3 provides a flowchart describing the interaction in the climate control mode. After the vehicle occupant selects the climate control mode as indicated by label 52, the vehicle control system provides feedback to the occupant that the system is indeed in the climate control mode as indicated by block 54. This feedback may be a voice stating the mode, lighting of an indicator, text on a screen, or the like. Next the occupant selects a parameter to be adjusted. The user may say “temperature” as indicated by label 82 to adjust the vehicle compartment temperature. The system then enters a temperature submode as indicated by block 84 in which it is ready to accept an appropriate value for a temperature value as indicated by label 86. Upon receiving sufficient information from the user, the system sets the temperature as indicated by block 88. Advantageously, the dialog based voice recognition component of the present invention is also capable of interpreting a phrase which completely specifies the necessary parameters to adjust the vehicle compartment temperature. For example, the occupant may state “turn up the AC” and the system will increase the amount of cooling from the air conditioner. It should be appreciated that an equivalent to each voice commands may be alternatively entered by an appropriate selection with the HMI. Similarly, the user may say “fan speed” as indicated by label 90 to adjust the fan speed. The system then enters a fan speed sub-mode as indicated by block 92 in which it is ready to accept an appropriate value for a fan speed as indicated by label 94. Upon receiving sufficient information from the user, the system sets the fan speed as indicated by block 96. Again, the user may enter a phrase which completely specifies the fan speed parameters (e.g. “turn down the fan”). The fan direction is adjusted by the user saying (or entering in the HMI) “direction” as indicated by label 100 thereby causing the system to enter a fan direction sub-mode as indicated by block 102. Next, a suitable direction parameter as indicated by label 104 is entered which cause the system to adjust the fan direction (block 106). The blower air source is adjusted by the user saying (or entering in the HMI) “recirculation” as indicated by label 110 thereby causing the system to enter a recirculation sub-mode as indicated by block 112. Next, the user decides whether to change the recirculation value as indicated by label 114 which causes the system to adjust the fan direction (block 116). If the user decides not to change the recirculation as indication by label 118, the system returns to idle. The rear defrost is adjusted by the user saying (or entering in the HMI) “rear defrost” as indicated by label 120 thereby causing the system to enter a rear defrost sub-mode as indicated by block 132. Next, the user decides whether to change the rear defrost value as indicated by label 134 which causes the system to adjust the rear defrost (block 136). If the user decides not to change the rear defrost as indicated by label 138, the system returns to idle. Alternatively, the user may directly have the rear defrost turned on by saying “turn on rear defrost.” The roof is adjusted by the user saying (or entering in the HMI) “roof” as indicated by label 140 thereby causing the system to enter a roof sub-mode as indicated by block 142. Next, the user decides whether to change the roof value as indicated by label 144 which causes the system to adjust the roof (block 146). If the user decides not to change the roof as indicated by label 148, the system returns to idle. Again, if the user says “open the roof” block 146 is directly reach by the system and the roof is opened. The seat temperature is adjusted by the user saying (or entering in the HMI) “seat temperature” as indicated by label 150 thereby causing the system to enter a seat temperature sub-mode as indicated by block 152. The user specifies the parameters for adjusting the seat temperature as indicated by label 154. If the user does not provide which seat to adjust the temperature, the system prompts the user to identify which seat as indicated by block 156. The user then responds thereby causing the system to adjust the seat temperature as indicated by block 158.

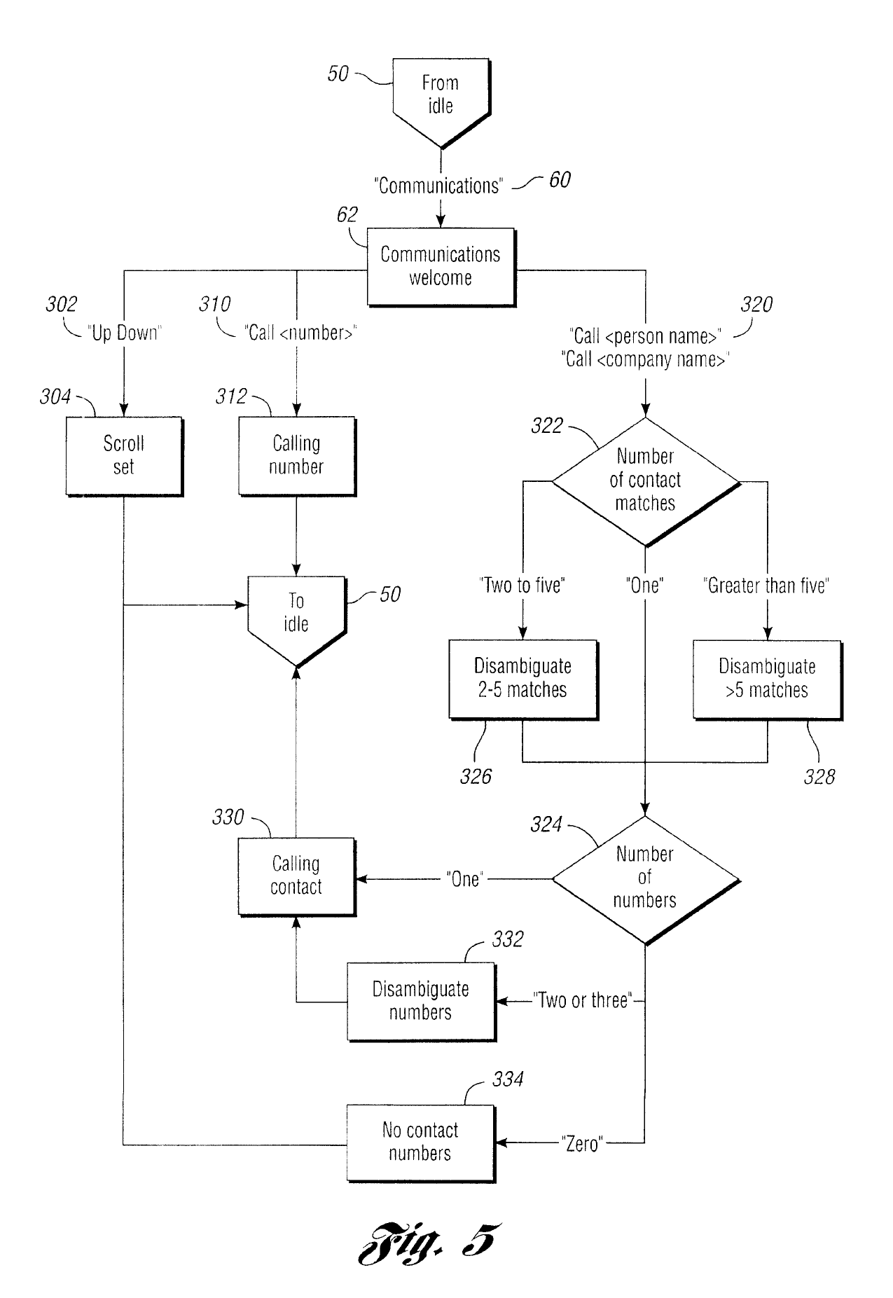

With reference to FIG. 4, a flowchart describing the interaction in the navigation mode is provided. After the vehicle occupant selects the navigation mode as indicated by label 56, the vehicle control system provides feedback to the occupant that the system is indeed in the navigation control mode as indicated by block 58. The navigation system provides information related to the vehicles position, directions on reaching a location, and similar map-like functions utilizing a system such as the GPS Satellite Navigation System. The user may zoom in on a map location by saying (or entering an equivalent command in the HMI) “zoom” as indicated by label 202 thereby causing the system to enter a zoom sub-mode as indicated by block 204 which in turn causes the system to zoom in on the displayed map (block 206). If the user wishes to move the focus of the map in a certain direction, the user says (or enters in the HMI) “move” as indicated by label 212 thereby causing the system to enter a move sub-mode as indicated by block 214 which in turn causes the system to move the location that is displayed on the map(block 216). If the user wishes to know the current location of the vehicle, the user may say “where am I” as indicated by label 218 which cause the vehicle control system of the invention to display the current location (block 220). Alternatively, the user may find their current location directly without passing through the navigation mode from the idle state 50 by saying “where am I.” If the user wishes to receive direction to a particular address or intersection, the user says (or enters in the HMI) “address” or “intersection” as indicated by label 222 thereby causing the system to enter an direction submode as indicated by block 224. Again, the user may reach block 224 from idle 50 directly by saying “give me directions to <address>.” At this point, the system retrieves direction information as indicated by block 226. If more then one address is matched the system prompts the user to select one as indicated by feedback loop 228. If there are no matches, the system reports this to the user as indicated by block 230. If there is one match, the system evaluates whether there is traffic along a given direction as shown in block 232. If there isn't traffic the distance to that address is calculated (block 234) and an evaluation is made whether fuel is required to reach that address (block 236) If fuel is not needed, the directions to that location are provided (block 238.) If fuel is needed, the user is prompted whether or not they desire directions to a gas station (block 240). If the user desires such directions, the direction are provided via feedback loop 242. If the directions provided to the user are reported as having traffic, the user is provided (block 244) the option of finding alternative directions via feedback loop 246 or to proceed with the provided directions via loop 248. Finally, if the user desires information regarding points of interest in a given location, the user the says (or enters in the HMI) “points of interest” (“POI”) as indicated by label 252 thereby causing the system to enter a direction sub-mode as indicated by block 254. The results of this query are then provided to the address mode to calculate direction as set forth above.

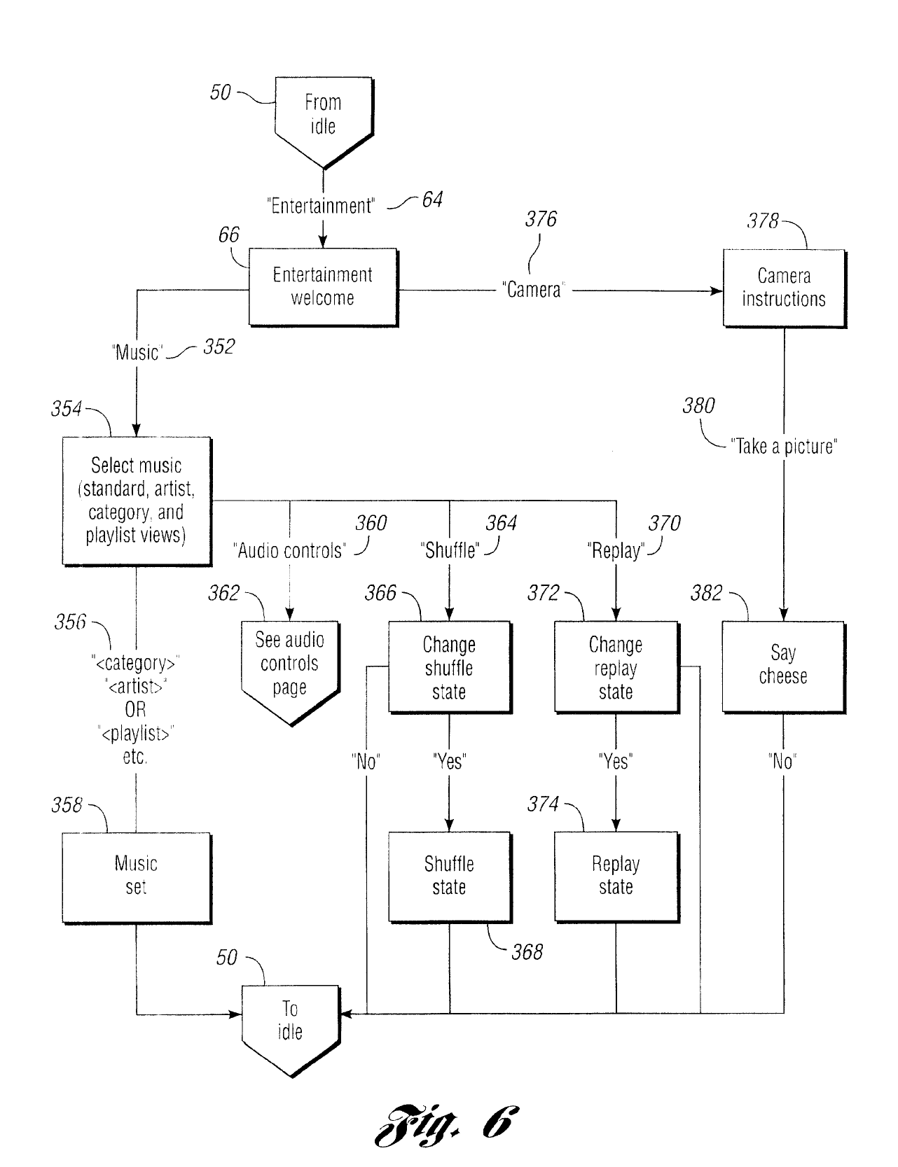

With reference to FIG. 5, a flowchart describing the interaction in the communications mode is provided. After the vehicle occupant selects the communications mode as indicated by label 60, the vehicle control system provides feedback to the occupant that the system is indeed in the communications control mode as indicated by block 62. The user may say “up” or “down” as indicated by label 302 to adjust the volume. The system then enters a scroll submode as indicated by block 304 in which the scroll is adjusted up or down depending on the command provided of the user. The user may say “call <number>” to call a particular phone number as indicated by label 310. (<number> is the number to be called.) In response to the users command, the system causes the desired phone number to be called as indicated by block 312. Block 312 may also be directly reached from idle 50 by the user saying “call <number>.” The user may also call a particular person or company by saying “call <person name>” or “call <company name>” as indicated by label 320. Upon receiving this command, the system determines the number of contacts as indicated by block 322. Block 322 may also be reached from idle 50 by the user saying a command such as “call John Smith.” If there is one match the number of phone number for that match are determined at block 324. If there are two to five matches the user is asked to select one at block 326 after which the number of phone numbers for the selected match are determined at block 324. If there are greater than 5 matches, the user is asked to select one at block 328 after which the number of phone numbers for the selected match are determined at block 324. After determination of the number of phone numbers for a given match, the number is called if there is only one number (block 330). Again, block 330 may also be reached directly from idle by the user issuing a command such as “call John Smith at work.” If there are two to three phone numbers, the user is asked to select one (block 332) which is then called (block 330). If there aren't any phone numbers (block 334) the system returns to idle.

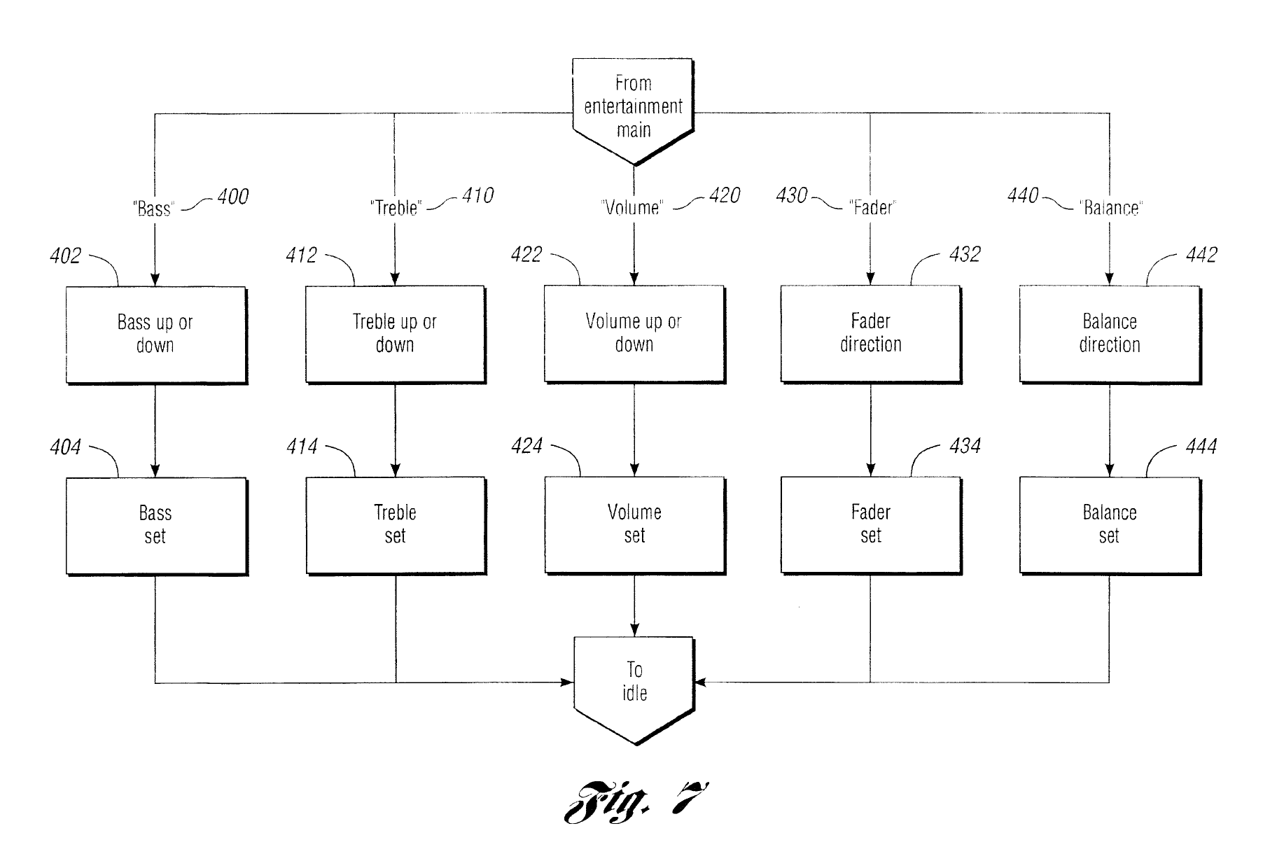

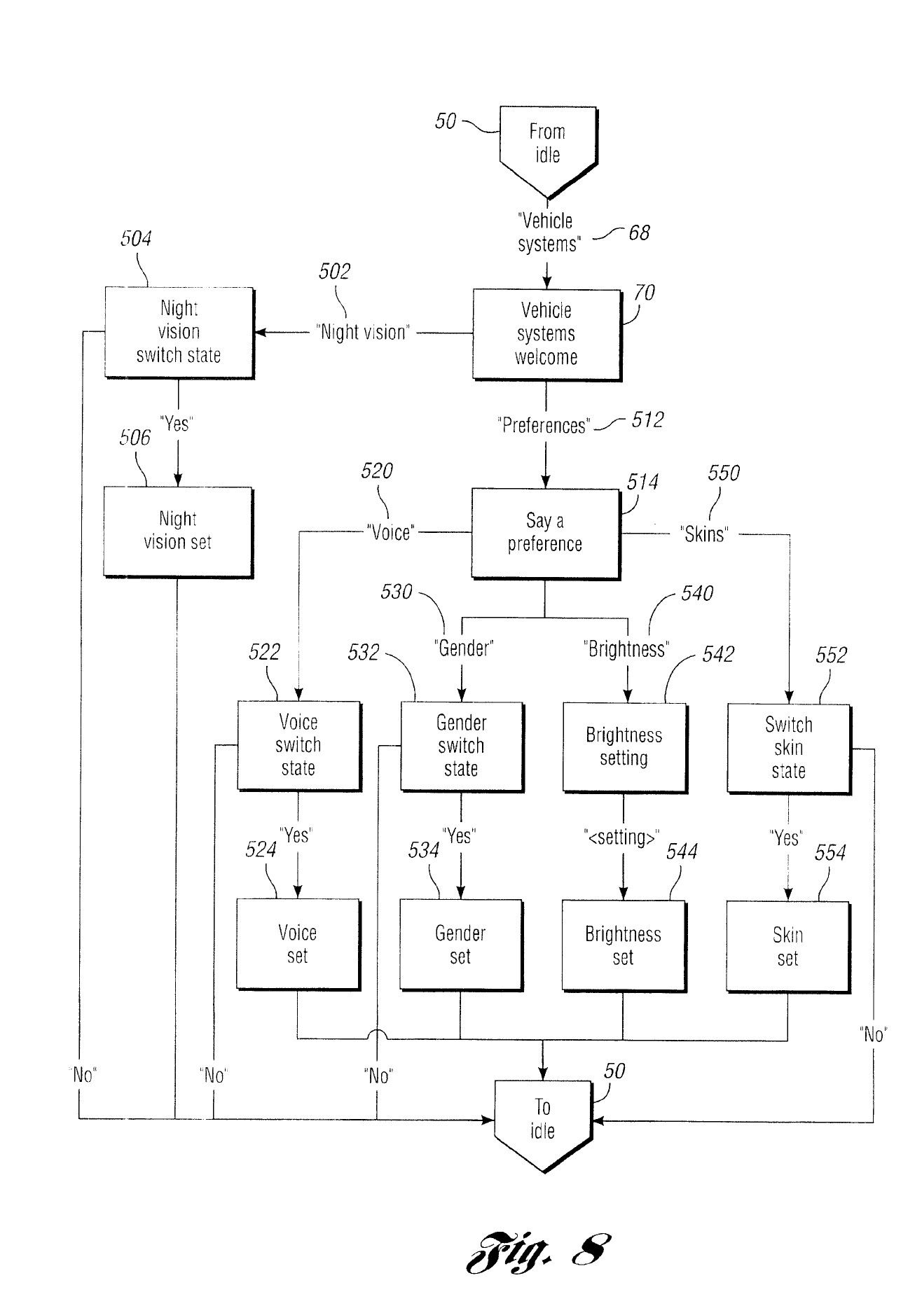

With reference to FIGS. 6 and 7, flowcharts describing the interaction in the entertainment mode are provided. After the vehicle occupant selects the entertainment mode as indicated by label 64, the vehicle control system provides feedback to the occupant that the system is indeed in the communications control mode as indicated by block 66. If the user wishes to play music, the user says (or enters an equivalent command in the HMI) “music” as indicated by label 352 thereby causing the system to enter a music sub-mode as indicated by block 354. The user then is prompted to provide information regarding the nature of the music to be played (category, artist, playlist, etc) as indicated by label 356. Upon receiving this information, the system plays the selected music (block 358.) Alternatively, block 358 may be directly reached by the user saying “play <artist name>.” While in the music submode, the user may also adjust the audio controls (label 360 and block 362) which is described in more detail below. The user may change the order in which selected music is played by saying “shuffle” as indicated by label 364 which causes the system to enter the shuffle submode as indicated by block 366. If the user decides to proceed the shuffle state is changed (block 368) if not the system returns to idle 50. Similarly, if the user says “replay” (label 370), the option of changing the replay state is provided as indicated by label 372. If the user decides to proceed, the replay state is changed (block 374), if not the system returns to idle 50. While in the entertainment mode, the user may also decided to operate a camera (or a pair of cameras) as indicated by label 376. By saying “camera” the user causes the system to enter into a camera submode as indicated by block 378. The user then cause the system to take a picture by saying the command “take a picture” or issuing an equivalent command to the HMI (label 380 and block 382). With reference to FIG. 7, a flow chart describing control of the audio controls is provided. The bass of the audio system is adjusted by the user saying (or entering in the HMI) “bass” as indicated by label 400. The user is then prompted as to whether the bass is to be adjusted up or down (block 402). Upon receiving the appropriate instruction, the base is adjusted as indicated by block 404. The treble of the audio system is adjusted by the user saying (or entering in the HMI) “treble” as indicated by label 410. The user is then prompted as to whether the treble is to be adjusted up or down (block 412). Upon receiving the appropriate instruction, the treble is adjusted as indicated by block 414. The volume of the audio system is adjusted by the user saying (or entering in the HMI) “volume” as indicated by label 420. The user is then prompted as to whether the volume is to be adjusted up or down (block 422). Upon receiving the appropriate instruction, the volume is adjusted as indicated by block 424. The fader of the audio system is adjusted by the user saying (or entering in the HMI) “fader” as indicated by label 430. The user is then prompted to provide the direction in which the fader is to be adjusted(block 432). Upon receiving the appropriate instruction, the fader is adjusted as indicated by block 434. The balance of the audio system is adjusted by the user saying (or entering in the HMI) “balance” as indicated by label 440. The user is then prompted to provide the direction in which the balance is to be adjusted(block 442). Upon receiving the appropriate instruction, the balance is adjusted as indicated by block 444.

With reference to FIG. 8, a flowchart describing the interaction in the vehicle systems mode is provided. After the vehicle occupant selects the entertainment mode as indicated by label 68, the vehicle control system provides feedback to the occupant that the system is indeed in the vehicle systems control mode as indicated by block 70. The vehicle's night system is adjusted by the user saying (or entering in the HMI) “night vision” as indicated by label 502. The user is then prompted as to whether or not the night vision system is to be adjusted (block 504). If the user decides to proceed, the state of the night vision system is switched (block 506) if not the system returns to idle. The preference of the vehicle control system may also be changed while in this mode. These preferences are adjusted by the user saying (or entering in the HMI) “preferences” as indicated by label 512 thereby causing the system to enter a preferences sub-mode as indicated by block 514. The user then may say “voice” (label 520) to enter a voice submode (block 522). If the user does indeed to change the voice state is changed as indicated by block 524. Otherwise the system returns to idle 50. The user then may say “gender” (label 530) to change the gender state if desired (blocks 532 and 534). The user then may say “brightness” (label 540) to change the brightness state of the instrument display if desired (blocks 542 and 544). Finally, the user then may say “skins” (label 550) to change the skin state (i.e., to display the analog gauges) if desired (blocks 552 and 554).

In another embodiment of the present invention, a method for controlling secondary vehicle functions is provided. The method of this embodiment utilizes the vehicle control system set forth above. The method of the invention comprises:

a) translating a voice command from a vehicle occupant into a form which communicates a control signal to the one or more secondary vehicle component;

b) prompting the vehicle occupant to input information specifying a vehicle parameter for which information in the voice command was not provided;

c) translating the information provided in step b into a form which communicates a control signal to the one or more secondary vehicle components; and

d) translating an input if provided from the vehicle occupant to a human machine interface into a form which communicates a control signal to the one or more secondary vehicle component.

It is readily apparent, that steps a, b, and c are performed by the speech recognition component set forth above.

In a particularly useful variation of the method of the invention, parameters for each secondary vehicle function are grouped together to form a vehicle control mode as set forth above for the vehicle control system of the invention. The vehicle control mode is selectable by the vehicle occupant by either providing a voice command to a speech recognition module or by the vehicle occupant interacting with an HMI. By either input methods, the vehicle occupant specifies parameters for a selected vehicle control mode after the vehicle mode is selected by the vehicle occupant. The useful vehicle control modes are the same as those set forth above. Finally, the utilization of an interfacing electronics system in the method of the invention are also the same as set forth above.

While the best mode for carrying out the invention has been described in detail, those familiar with the art to which this invention relates will recognize various alternative designs and embodiments for practicing the invention as defined by the following claims.

1. A vehicle control system comprising:
one or more vehicle components for adjusting secondary vehicle functions;
a dialog-based speech recognition component that responds to voice commands from a vehicle occupant, the speech recognition component communicating with the one or more vehicle components; and
a human machine interface that also communicates with the one or more vehicle components, the human machine interface capable of communicating in combination with and separate from the speech recognition component.

2. The vehicle control system of claim 1 wherein the speech recognition component comprises:
1. a first translating component for translating a voice command from a vehicle occupant into a form which communicates a control signal to the one or more vehicle components;
2. a prompting component for prompting the vehicle occupant to input information specifying a vehicle parameter for which information in the voice command was not provided; and
3. a second translating component for translating the information provided in step b into a form which communicates a control signal to the one or more secondary vehicle components.

3. The vehicle control system of claim 1 wherein comprises a module for grouping parameters together for each secondary vehicle function to form a vehicle control mode, the vehicle control mode being selectable by a vehicle occupant such that the vehicle occupant may then specify parameters for a selected vehicle control mode.

4. The vehicle control system of claim 3 wherein the selected vehicle control mode is selectable by a voice command.

5. The vehicle control system of claim 3 wherein the selected vehicle control mode is selectable by the vehicle occupant interacting with the human machine interface.

6. The vehicle control system of claim 3 wherein the vehicle control mode is selected from the group consisting of a climate control mode in which the vehicle occupant specifies parameters that adjust climate in a vehicle passenger compartment; a communications mode in which the vehicle occupant specifies parameters related to a telephone located in the vehicle passenger compartment; an entertainment mode in which the vehicle occupant specifies parameters that control a vehicle entertainment system; a navigation mode in which the vehicle occupant specifies parameters related to vehicle position; a vehicle systems mode in which the vehicle occupant specifies parameters related to the vehicle control system or any other predetermined vehicle parameter; and combinations thereof.

7. The vehicle control system of claim 1 wherein the speech recognition component comprises a central processing unit executing a sequence of computer commands that translates the voice command into a signal that is communicatable to the one or more system components.

8. The vehicle control system of claim 1 wherein the human machine interface is selected from the group consisting of a touch panel display, a switch, a capacitive sensor, a resistive sensor, a wheel, a knob, and a camera.

9. The vehicle control system of claim 1 wherein:
the vehicle control system further comprises an interfacing electronics system for providing a primary control analog or digital signal to the one or more vehicle components; and
the speech recognition component comprises a translating component for translating the voice command into a secondary control digital or analog signal which is provided to the interfacing electronics system.

10. The vehicle control system of claim 1 wherein:
the vehicle control system further comprises an interfacing electronics system for providing a primary control analog or digital signal to the one or more vehicle components; and
the human machine interface comprises a translating component for translating the voice command into a secondary control digital or analog signal which is provided to the interfacing electronics system.

11. The vehicle control system of claim 1 wherein the speech recognition component comprises a translating component for translating the voice command into a digital or analog signal which is provided to the one or more vehicle components.

12. The vehicle control system of claim 1 wherein the human machine interface comprises a translating component for translating an input from a vehicle occupant into a digital or analog signal which is provided to the one or more vehicle components.

13. A vehicle control system comprising:
one or more vehicle components for adjusting secondary vehicle functions;
a dialog-based speech recognition component that responds to voice commands from a vehicle occupant communicating with the one or more vehicle components, the speech recognition component comprising:
1. a first translating component for translating a voice command from a vehicle occupant into a form which communicates a control signal to the one or more secondary vehicle component;
2. a prompting component for prompting the vehicle occupant to input information specifying a vehicle parameter for which information in the voice command was not provided; and
3. a second translating component for translating the information provided in step b into a form which communicates a control signal to the one or more secondary vehicle components; and
a human machine interface that also communicates with the one or more vehicle components, the human machine interface capable of communicating in combination with and separate from the speech recognition component.

14. The vehicle control system of claim 13 wherein the vehicle control system comprises a component for grouping parameters together for each secondary vehicle function to form a vehicle control mode, the vehicle control mode selectable by a vehicle occupant such that the vehicle occupant may then specify parameters for a selected vehicle control mode.

15. The vehicle control system of claim 14 wherein the selected vehicle control mode is selected by a voice command.

16. The vehicle control system of claim 14 wherein the selected vehicle control mode is selected by the vehicle occupant interacting with the human machine interface.

17. The vehicle control system of claim 14 wherein the vehicle control mode is selected from the group consisting of a climate control mode in which the vehicle occupant specifies parameters that adjust climate in a vehicle passenger compartment; a communications mode in which the vehicle occupant specifies parameters related to a telephone located in the vehicle passenger compartment; an entertainment mode in which the vehicle occupant specifies parameters that control a vehicle entertainment system; a navigation mode in which the vehicle occupant specifies parameters related to vehicle position; a vehicle systems mode in which the vehicle occupant specifies parameters related to the vehicle control system or any other predetermined vehicle parameter; and combinations thereof.

18. The vehicle control system of claim 13 wherein the speech recognition component comprises a central processing unit executing a sequence of computer commands that translates the voice command into a signal which is useable to communicate with the one or more system components.

19. The vehicle control system of claim 13 wherein the human machine interface is selected from the group consisting of a touch panel display, a switch, a capacitive sensor, a resistive sensor, a wheel, a knob, and a camera.

20. The vehicle control system of claim 13 wherein:
the vehicle control system further comprises an interfacing electronics system for providing a primary control analog or digital signal to the one or more vehicle components; and
the speech recognition component comprises a translating component for translating the voice command into a secondary control digital or analog signal which is provided to the interfacing electronics system.

21. The vehicle control system of claim 13 wherein:
the vehicle control system further comprises an interfacing electronics system for providing a primary control analog or digital signal to the one or more vehicle components; and
the speech recognition component comprises a component for translating the voice command into a secondary control digital or analog signal which is provided to the interfacing electronics system.

22. The vehicle control system of claim 13 wherein the speech recognition component comprises a translating component for translating the voice command into a digital or analog signal which is provided to the one or more vehicle components.

23. The vehicle control system of claim 13 wherein the human machine interface comprises a translating component for translating an input from a vehicle occupant into a digital or analog signal which is provided to the one or more vehicle components.

24. A method for controlling secondary vehicle functions, the method comprising:
a) translating a voice command from a vehicle occupant into a form which communicates a control signal to the one or more secondary vehicle component;
b) prompting the vehicle occupant to input information specifying a vehicle parameter for which information in the voice command was not provided;
c) translating the information provided in step b into a form which communicates a control signal to the one or more secondary vehicle components; and
d) translating an input if provided from the vehicle occupant to a human machine interface into a form which communicates a control signal to the one or more secondary vehicle component.

25. The method of claim 24 wherein parameters are grouped together for each secondary vehicle function to form a vehicle control mode, the vehicle control mode selectable by a vehicle occupant such that the vehicle occupant may specify parameters for a selected vehicle control mode after the vehicle mode is selected by the vehicle occupant.

26. The method of claim 25 wherein the selected vehicle control mode is selected by a voice command.

27. The method of claim 25 wherein the selected vehicle control mode is selected by the vehicle occupant interacting with the human machine interface.

28. The method of claim 25 wherein the vehicle control mode is selected from the group consisting of a climate control mode in which the vehicle occupant specifies parameters that adjust climate in a vehicle passenger compartment; a communications mode in which the vehicle occupant specifies parameters related to a telephone located in the vehicle passenger compartment; an entertainment mode in which the vehicle occupant specifies parameters that control a vehicle entertainment system; a navigation mode in which the vehicle occupant specifies parameters related to vehicle position; a vehicle systems mode in which the vehicle occupant specifies parameters related to the vehicle control system or any other predetermined vehicle parameter; and combinations thereof.

29. The method of claim 24 wherein step a is performed by a speech recognition component.

30. The method of claim 29 wherein the speech recognition component comprises a central processing unit executing a sequence of computer commands that translates the voice command into a signal which is useable to communicate with the one or more system components.

31. The method of claim 24 wherein the human machine interface is selected from the group consisting of a touch panel display, a switch, a capacitive sensor, a resistive sensor, a wheel, a knob, and a camera.

32. The method of claim 24 wherein the speech recognition component translates the voice command into a first digital or analog signal which is provided to an interfacing electronics system, the interfacing electronics system providing a second analog or digital signal to the one or more vehicle components.

33. The method of claim 24 wherein the human machine interface translates an input from a vehicle occupant into a digital or analog signal which is provided to an interfacing electronics system, the interfacing electronics system providing a second analog or digital signal to the one or more vehicle components.

34. The method of claim 24 wherein the speech recognition component translates the voice command into a digital or analog signal which is provided to the one or more vehicle components.

35. The method of claim 24 wherein the human machine interface translates an input from a vehicle occupant into a digital or analog signal which is provided to the one or more vehicle components.
